(19) United States
(12) Patent Application Publication
(10) Pub. No.: US 2025/0158277 A1
(43) Pub. Date: May 15, 2025

(54) PID CONTROLLER FOR MODULATING ANGLES ON EXTERNAL ANTENNAS

(71) Applicant: Cisco Technology, Inc., San Jose, CA (US)

(72) Inventor: Carolina A. SALAZAR LAGUNES, Mexico City (cdmx) (MX)

(21) Appl. No.: 18/509,180

(22) Filed: Nov. 14, 2023

(51) Int. Cl. H01Q 3/08; H04W 84/12; H04W 88/08

(52) U.S. Cl. CPC H01Q 3/08; H04W 84/12; H04W 88/08

(57) ABSTRACT

Embodiments herein describe adjusting an angle of an antenna used by an AP based on client feedback. For example, the AP can use radio frequency (RF) data from mobile user devices (e.g., smartphones, laptops, tablets, etc.) to determine that a radiation pattern of the external antenna is no longer at an optimal position to provide service to the user devices. The AP can then use a PID controller to adjust the antenna so that it faces in an direction that provides better Wi-Fi service to the user devices.

### TECHNICAL FIELD

Embodiments presented in this disclosure generally relate to adjusting an antenna used user radio frequency (RF) data and a proportional-integral-derivative (PID) controller.

### BACKGROUND

Currently, the angle of external antennas used in Wi-Fi deployments is manually set to provide coverage on a particular space. Site surveys are often used to validate the radiation pattern to ensure it has the proper angle and power. However, the coverage area is set based on an assumption of where the users will be when the Wi-Fi deployment is put to use. If these assumptions are wrong, the cell coverage will be misaligned. For large adjustments, a technician must adjust the angle of the antenna manually.

Some algorithms modulate access points (APs) power based on client feedback, looking to transmit at a value that will provide the best performance to clients while avoiding creating issues like noise or interference with other APs. These algorithms work well in more static environments like an office or a store but perform poorly in other spaces like a stadiums or concert venues where people can gather in different areas. Thus, simply changing power does not solve the problem when people can move to different areas in a large venue.

### BRIEF DESCRIPTION OF THE DRAWINGS

So that the manner in which the above-recited features of the present disclosure can be understood in detail, a more particular description of the disclosure, briefly summarized above, may be had by reference to embodiments, some of which are illustrated in the appended drawings. It is to be noted, however, that the appended drawings illustrate typical embodiments and are therefore not to be considered limiting; other equally effective embodiments are contemplated.

FIG. 1 is a system where an AP uses a PID controller to adjust the angle of an external antenna based on feedback from user devices, according to one embodiment.

FIG. 2 illustrates a PID controller, according to one embodiment.

FIG. 3 is a flowchart for adjusting the angle of an external antenna using RF data from user devices, according to one embodiment.

FIGS. 4A-4C illustrate changing the angle of an antenna based on movement of user devices, according to one embodiment.

FIGS. 5A and 5B illustrate changing the angle of an antenna based on different setups in a venue, according to one embodiment.

To facilitate understanding, identical reference numerals have been used, where possible, to designate identical elements that are common to the figures. It is contemplated that elements disclosed in one embodiment may be beneficially used in other embodiments without specific recitation.

### DESCRIPTION OF EXAMPLE EMBODIMENTS

### Overview

One embodiment presented in this disclosure is a Wi-Fi access point (AP) that includes a proportional-integral-derivative (PID) controller and memory storing an application configured to receive radio frequency (RF) data from a plurality of user devices and determine a setpoint for the PID controller based on the RF data. Moreover, the PID controller is configured to control a motor to adjust a position of an antenna based on the setpoint.

One embodiment presented in this disclosure is a non-transitory computer readable medium encoding instructions, which, when executed by a processor of an AP, cause the AP to receive RF data from a plurality of user devices and determine a setpoint for a PID controller based on the RF data. Moreover, the PID controller is configured to control a motor to adjust a position of an antenna based on the setpoint.

One embodiment presented in this disclosure is a system that includes an antenna and a Wi-Fi AP configured to receive RF data from a plurality of user devices, determine a setpoint for a PID controller in the Wi-Fi AP based on the RF data, and control a motor, using the PID controller, to adjust a position of the antenna based on the setpoint.

### EXAMPLE EMBODIMENTS

Embodiments herein describe adjusting an angle of an external antenna used by an AP based on client feedback. For example, the AP can use radio frequency (RF) data from mobile user devices (e.g., smartphones, laptops, tablets, etc.) to determine that a radiation pattern of the external antenna is no longer at an optimal position to provide service to the user devices. The AP can then use a PID controller to adjust the antenna so that it faces in an direction that provides better Wi-Fi service to these user devices.

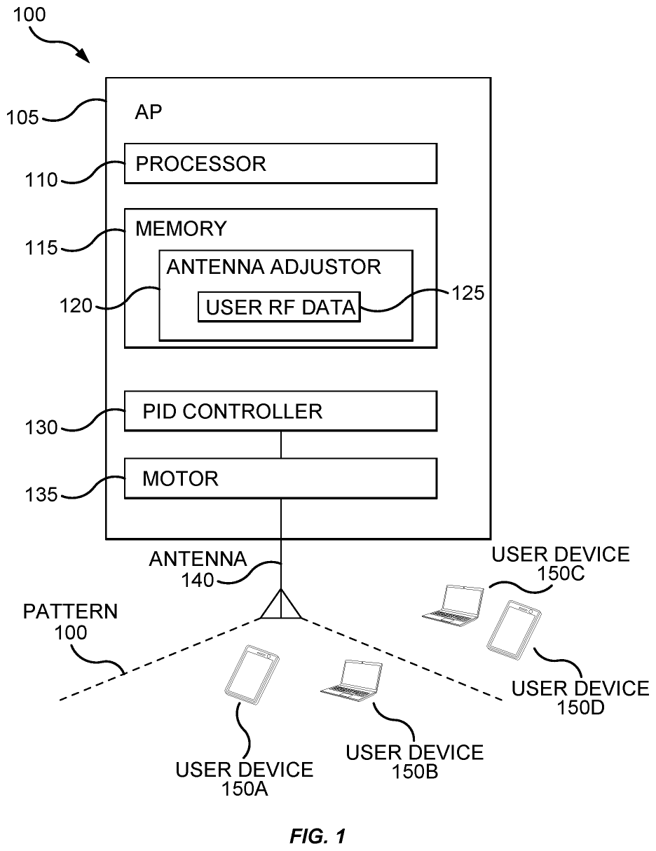

FIG. 1 is a system 100 where an AP 105 uses a PID controller 130 to adjust the angle of an external antenna 140 based on feedback from user devices 150, according to one embodiment. The AP 105 (e.g., a Wi-Fi AP) includes a processor 110 which can represent any number of processing elements (e.g., central processing units (CPUs) or application specific integrated circuits (ASICs) that have any number of processing cores. The AP 105 also includes memory 115 which can include volatile memory, non-volatile memory, and combinations thereof.

In this example, the memory 115 stores an antenna adjustor 120 (e.g., a software application) that determines a new angle for adjusting the antenna 140. The antenna adjustor 120 can determine a new angle for the antenna 140 using user RF data 125 which is received from the user devices 150 that are in communication with the AP 105. For example, the user RF data 125 can include metrics associated with the communication link between the user devices 150 and the AP 105 such as received signal strength indicator (RSSI) or signal to noise ratio (SNR). The functions of the antenna adjustor 120 will be discussed in more detail below.

The AP 105 also includes a PID controller 130 that is coupled to a motor 135, which in turn changes the position of the antenna 140. The PID controller 130 (which is also called a three-term controller) is a control loop mechanism employing feedback that provides continuously modulated control. In one embodiment, the PID controller 130 continuously calculates an error value as the difference between a desired setpoint and a measured process value from the motor 135. The PID controller 130 applies a correction based on proportional, integral, and derivative terms (denoted P, I, and D respectively). The PID controller 130 controls the motor 135 until the motor has moved the antenna 140 into a position that matches the setpoint (e.g., the new antenna position provided by the antenna adjustor 120.

FIG. 1 illustrates various user devices 150 that are in, or close by, a radiation pattern 160 of the antenna 140. The radiation pattern 160 is a graphical representation of the radiation properties of the antenna 140 to illustrate how the antenna 140 radiates Wi-Fi signals out into space (or how it receives Wi-Fi signal from the user devices 150). In this example, the user devices 150A and 150B are within the radiation pattern 160 but user devices 150C and 150D are not. Although the user devices 150C and 150D are not within the radiation pattern 160, the antenna 140 may still receive signals from these devices, but the RSSI or SNR of the received signals may be lower than the signals received from user devices 150A and 150B. For example, the radiation pattern 160 may indicate a region where Wi-Fi communication is optimal, but Wi-Fi communication can still occur with user devices 150C and 150D that are outside of the radiation pattern 160 although it may have degraded performance such as dropped packets or being forced to use a reduced modulation coding scheme (MCS).

The antenna adjustor 120 can use the user RF data (e.g., the RSSI or SNR data) or the locations of the user devices 150 to determine a new setpoint of the antenna 140. For example, as discussed in more detail below, the antenna adjustor 120 can select a new setpoint for the PID controller 130 that moves the radiation pattern 160 so that it includes each of the user devices 150. This may improve the ability of the AP 105 to communicate with the user devices 150.

In this example, the antenna 140 is external to the AP 105 in that it is not included within a form factor or “box) of the AP 105. The antenna 140 can be mounted onto a side of the AP 105 but this is not a requirement. For instance, the antenna 140 may be mounted on some other structure (e.g., a support beam) instead of the AP 105. For example, the antenna 140 and the AP 105 may be mounted on a common support (e.g., the same support beam). In that case, the motor 135, and possibly the PID controller 130, may also be mounted on the support beam rather than being disposed within the AP 105.

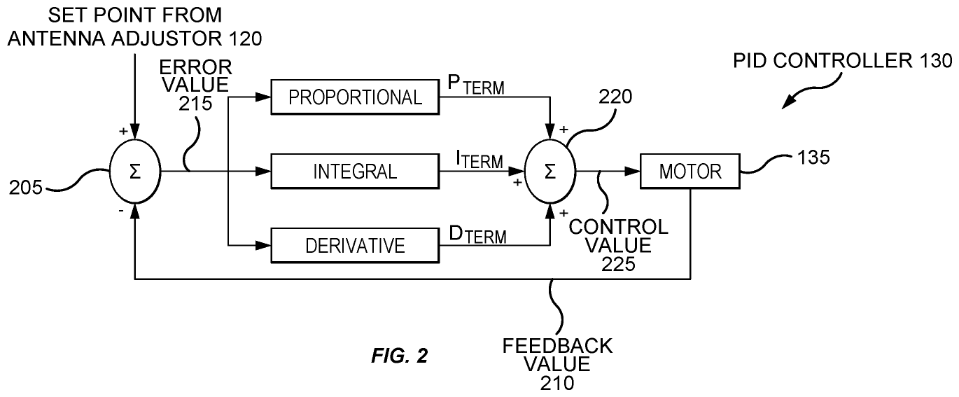

FIG. 2 illustrates one example of the PID controller 130 in FIG. 1, according to one embodiment. The PID controller 130 receives a setpoint from the antenna adjustor 120 as an input. The setpoint may be a desired angle or position of the external antenna (not shown). When the AP is first powered on or installed, the initial setpoint may be set manually by a technician. That is, the technician may provide a default setpoint for the antenna adjustor 120 to output. This initial setpoint may be based on the technician's knowledge of the environment and based on neighboring APs and their antenna. For example, the initial setpoint may point the antenna in a direction where the most number of people are predicted to congregate, without substantially overlapping with the radiation pattern of an antenna for a neighboring AP or APs.

The PID controller 130 includes a summer 205 that subtracts the setpoint received from the antenna adjustor 120 with a feedback value 210 from the motor 135. For example, the feedback value 210 may be the current setpoint of the motor 135, or the current position of the motor 135 which in turns set the position of the antenna (not shown in FIG. 2).

Subtracting the feedback value 210 from the setpoint results in an error value 215 which is provided to the proportional, integral, and derivative blocks of the PID controller 130. In general, the proportional block outputs a current or present error, the iterative block is a historical error, and the derivative is a future error. A second summer 220 adds the outputs of the proportional, integral, and derivative blocks to yield a control value 225 for the motor 135. As the output of the motor 135 changes in response to the control value 225, it is again fed back and the process continues to provide an updated control value 225 to the motor. Once the error value 215 goes to zero (e.g., the setpoint is the same as the feedback value 210), then no more adjustments are made to the motor 135.

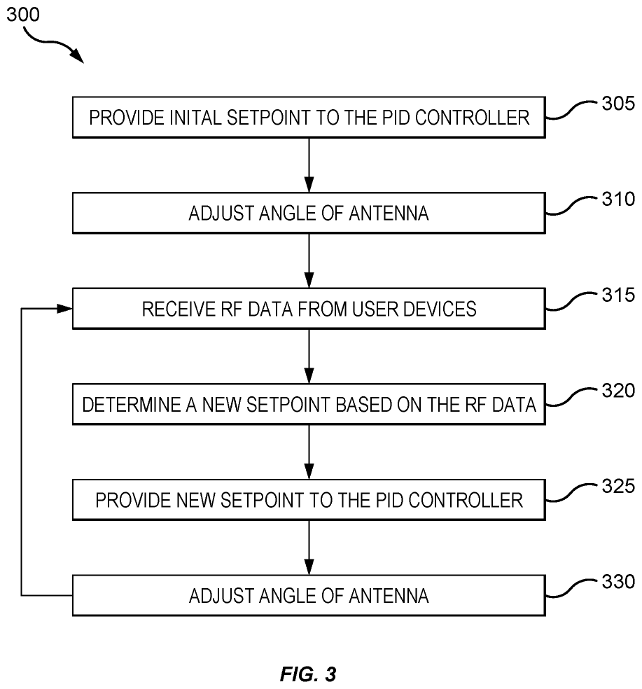

FIG. 3 is a flowchart of a method 300 for adjusting the angle of an external antenna using RF data from user devices, according to one embodiment. At block 305, an AP (or the antenna adjustor 120 in the AP 105 in FIG. 1) provides an initial setpoint to the PID controller. As discussed above, the initial setpoint may be provided by a technician. The technician may set the initial setpoint so the antenna faces the area that will cover the most user devices, but without substantially overlapping with neighboring antenna radiation patterns. For example, if the AP is deployed in stadium, the initial setpoint may point the antenna towards a seating area, rather than an area that includes an aisle.

At block 310, the PID controller uses the initial setpoint to adjust the angle of the antenna. For example, when the AP powers on, the PID controller receives the initial setup and controls the motor in order to adjust the antenna so it is positioned according to the initial setpoint.

At block 315, the AP receives RF data from user devices. This RF data can include RSSI and SNR information which the AP can use to determine whether the user devices are in the radiation pattern (or coverage area) of the antenna, or at a fringe of the radiation pattern, but still able to communicate with the AP. That is, the antenna adjustor can use the RF data to determine whether it should adjust the position of the antenna in response to determining how many of the user devices are in the radiation pattern and how many are not.

In one embodiment, the RF data indicates locations of the user devices in the environment. This could better tell the antenna adjustor how to adjust the position of the antenna so that more of the user devices are within the radiation pattern of the antenna.

At block 320, the antenna adjustor determines a new setpoint based on the RF data. For example, the antenna adjustor may determine that increasing the angle of the antenna by 20 degrees may cover 10 additional user devices while still providing sufficient coverage for the user devices already in the radiation pattern of the antenna. This could be done using a simulation or by knowing the location of the user devices in a floorplan or map of the environment.

In other examples, the antenna adjustor may not know which direction it should adjust the antenna, but only that the external antenna should be adjusted because the RSSI or SNR of some user devices have fallen below a threshold. In that case, the antenna adjustor may choose a direction (e.g., a default direction or an educated guess based on the RF data) and move the antenna in the direction. If the updated user RF data shows that doing so improves the RSSI or SNR of the user devices, the antenna adjustor may continue to move the antenna in the direction. However, if the updated RF data shows that moving the antenna in that direction reduces the RSSI and SNR of the user devices (or improves the RSSI/SNR for some user devices but reduces the RSSI and SNR for many more user devices), the antenna adjustor may change the direction it adjusts the antenna. In this embodiment, the antenna adjustor uses a trial-and-error approach to adjusting the setpoint.

At block 325, the antenna adjustor provides the new setpoint to the PID controller. Here, the PID controller can function as shown in FIG. 2 where the new setpoint is subtracted from the feedback value to provide an error value to the proportional, integral, and derivative blocks. Their outputs can then be summed to provide a new control value for the motor.

At block 330, the motor adjust the position of the antenna. In one embodiment, the antenna may be pivotally mounted to the motor such that the motor can change the angle of the antenna relative to the AP (e.g., rotate the antenna at a pivot point). However, the embodiments are not limited to any particular motion to adjust the position of the AP. For example, the motor could slide the antenna to a different location.

The method 300 then returns to block 315 where the AP receives additional RF data from the user device. Using this data, the antenna adjustor may determine the current position of the antenna is optimal, and keep the current setpoint. However, if not, the antenna adjustor can generate a new setpoint and blocks 320, 325, and 330 can repeat as many times as is necessary.

In one embodiment, the method 300 can run at predefined intervals, or can run continuously. For example, the method 300 may permit the antenna adjustor to determine a new setpoint (or determine to keep the current setpoint) every hour or every day to avoid constantly moving the antenna, and thus, reduce the amount of wear and tear on the motor.

In other embodiments, the method 300 may run continuously where the AP may constantly receive user RF data which the antenna adjustor can use to determine an updated setpoint or to keep the current setpoint. In yet other embodiments, the method 300 can operate continuously at some time windows but not at others. For example, if the AP is deployed in an area that is occupied only at certain times (e.g., a business during store hours or a baseball stadium only when there is a baseball game or other event), the method 300 may operate continuously when the environment is occupied but not run with the environment is not occupied. For example, if the AP does not receive user RF data during a defined time frame, it may switch to a low power mode and only listen for user RF data intermittently. During this time, the antenna adjustor may not be permitted to calculate a new setpoint, or the antenna adjustor maintains the current setpoint since it does not receive any new user RF data.

When user RF data is again received when a new user device begins to send probes to the AP, the AP can then wake up and begin sending the user RF data to the antenna adjustor. In turn, the antenna adjustor can determine whether to update the setpoint which in turn adjusts the antenna.

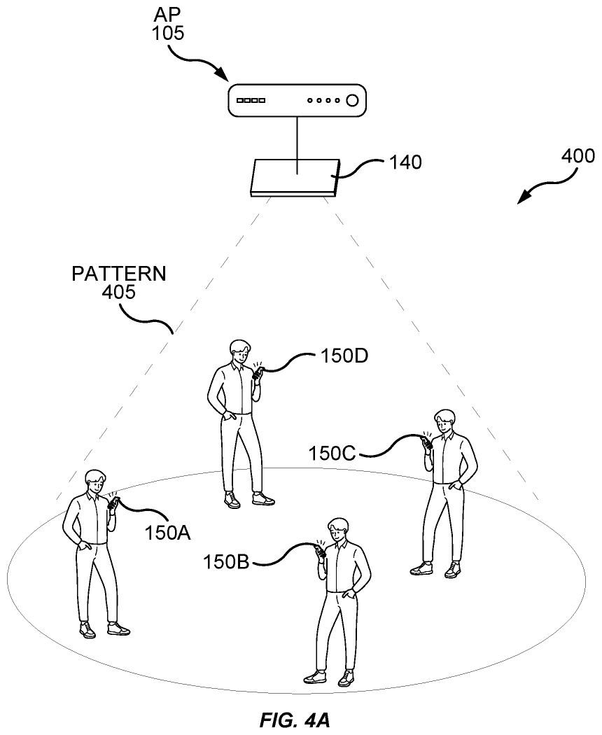

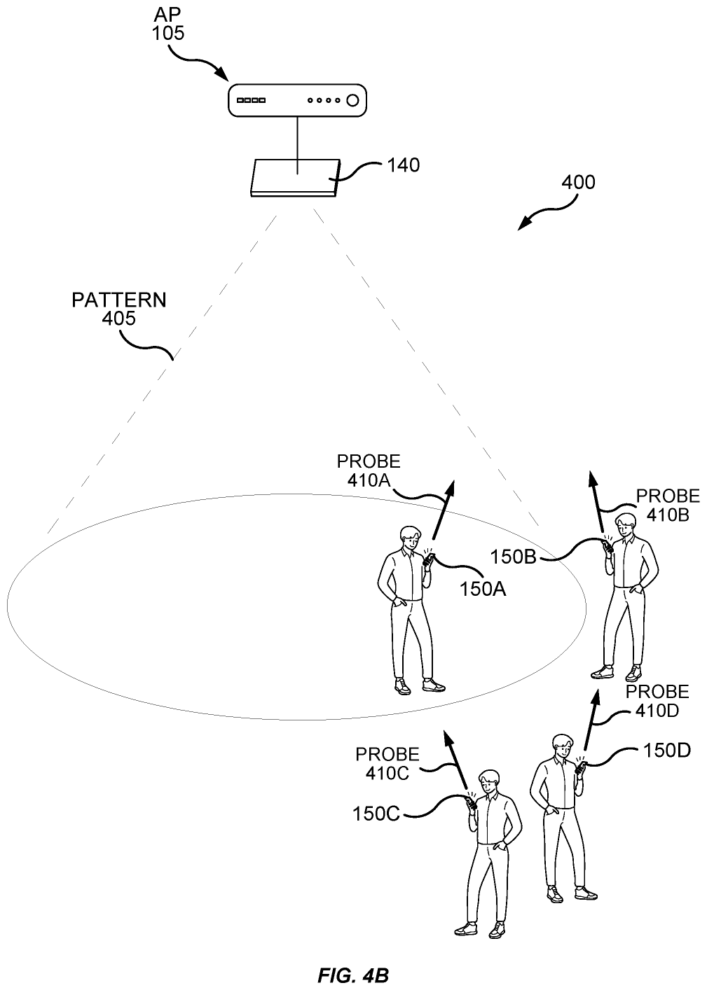

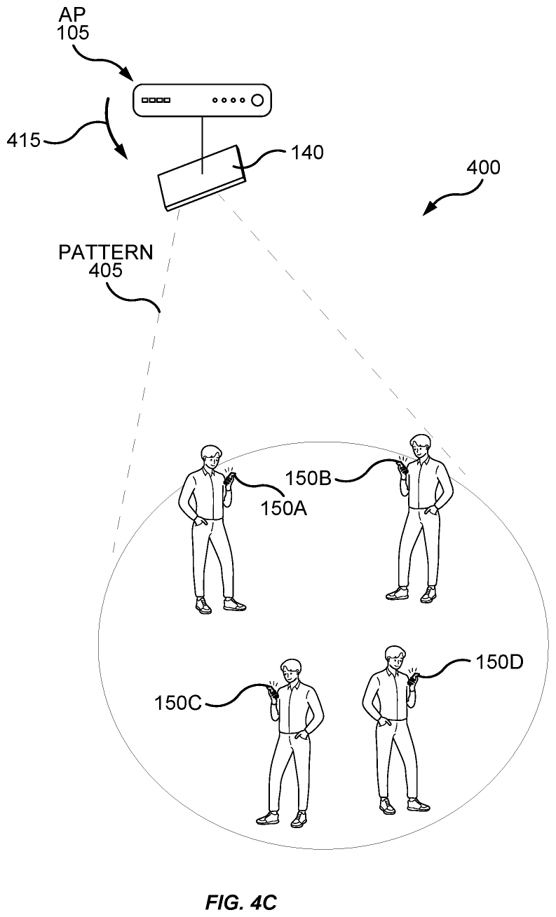

FIGS. 4A-4C illustrate changing the angle of an antenna based on movement of user devices, according to one embodiment. FIG. 4A illustrates a first time period (referred to as Time A) of an environment 400 when the user devices 150 are within the radiation pattern 405 of the antenna 140. Since the pattern 405 includes all the user devices 150 at Time A, the antenna adjustor may determine to maintain the current setpoint for the PID controller in the AP 105. As a result, the antenna 140 remains in its current position.

FIG. 4B illustrate a second time period (referred to as Time B) after Time A. Now, several of the user devices 150 have been carried outside of the radiation pattern 405 of the antenna 140. For example, if the environment 400 is a sport stadium, at Time A, the people holding the user devices 150 may be sitting in a seating area watching the game. However, at Time B, the game may have been paused (e.g., during halftime) and many of the people have moved from the seating area to a different part of the stadium to, e.g., buy concession or use the restroom.

At Time B, the AP 105 can receive probes 410 from the user device 150 which includes user RF data. As discussed above, the AP can use this RF data to determine that user devices 150B-D have moved outside the radiation pattern. For example, their RSSI or SNR may have fallen below a threshold. Thus, while the user devices 150B-D may not be in the radiation pattern 405, they may be close enough so that the AP receives the probes 410B-D.

In response, the antenna adjustor in the AP 105 provides a new setpoint for the PID controller so the controller can adjust the position of the antenna 140 so its radiation pattern 405 captures all (or at least more) of the user devices 150.

FIG. 4C illustrates a Time C after Time B where the PID controller and motor have adjusted an angle 415 of the antenna 140 relative to the AP 105. This angle adjustment moves the radiation pattern 405 so that more (in this case, all) of the user devices 150 are again within the pattern 405, which may result in improved Wi-Fi communication between the AP 105 and the user devices 150.

If, after halftime, the user devices 150 are moved back to their locations shown in FIG. 4A, then the process can repeat where the AP 105 uses updated RF data from the user devices 150 to adjust the antenna 140 so its radiation pattern 405 is again at the position illustrated in FIG. 4A. In this manner, the AP 105 can adjust the antenna 140 dynamically as the mobile user devices 150 are moved throughout the environment.

In one embodiment, there may be limits to adjusting the antenna 140. For example, the user devices 150 may move into a coverage area of a neighboring AP. If the AP 105 were to adjust its antenna 140 to also cover that area, it can result in a wasteful coverage overlap where two APs cover the same area. Further, user devices may have moved into the area that the AP 105 previously covered, and now have no service since the AP 105 has moved its antenna to cover the same area as a neighboring AP.

To avoid this, a technician may set limits on the antenna adjustor so it cannot move the radiation pattern so it substantially overlaps with a neighboring AP. For example, the technician may permit the AP 105 to moves its radiation pattern 405 so it can cover at most 15% of the same area covered by a neighboring AP. Put differently, a technician may know what areas of the environment should be covered by which AP. The technician can set limits on the antenna adjustor, PID controller, or motor in each AP so the APs cannot adjust the antenna to encroacher too far into the coverage area for a neighboring AP (although some overlap may be tolerated and can be useful).

In sum, FIGS. 4A-4C illustrate how the embodiments herein can dynamically adjust an external antenna to follow mobile client devices as they move around an environment.

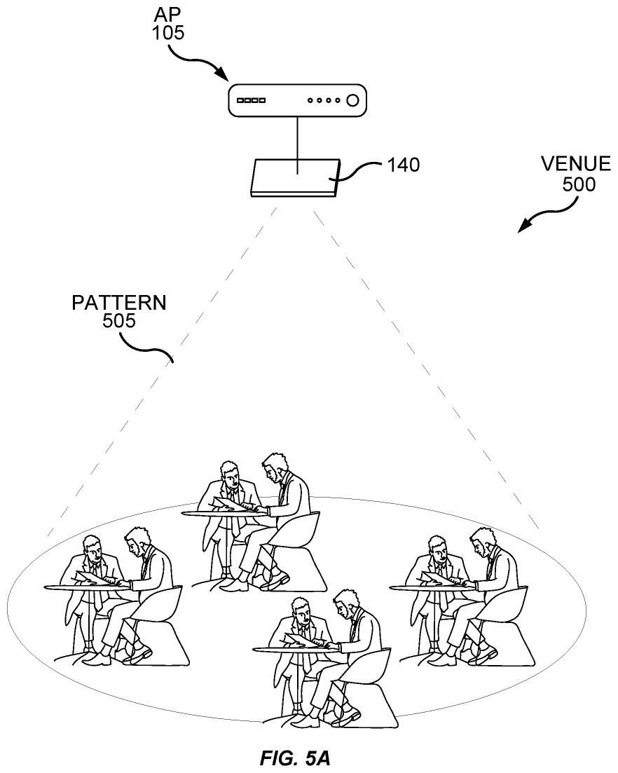

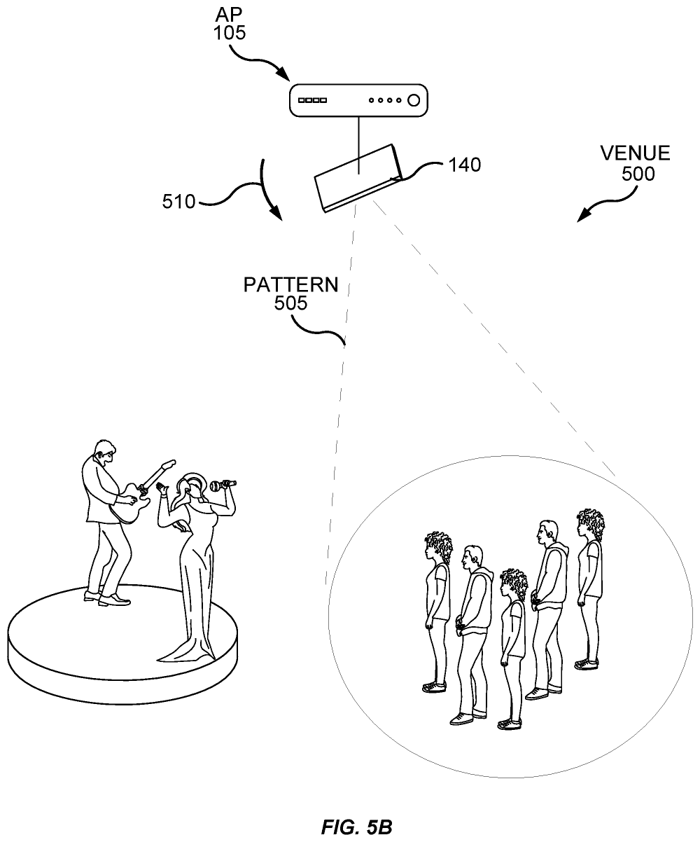

FIGS. 5A and 5B illustrate changing the angle of an antenna based on different setups in a venue, according to one embodiment. FIG. 5A illustrates a first setup or configuration of a venue 500. For example, the venue 500 may be an event venue, stadium, or conference center. At the time illustrated in FIG. 5A, the venue 500 is configured to have tables, where people are sitting (e.g., a wedding party or restaurant seating). The antenna 140 may have a default position where its radiation pattern 505 is directly beneath the antenna 140 and the AP 105. In this example, the radiation pattern 505 is in an optimal position since it covers the tables where the people are sitting (and the user devices they are carrying/using).

FIG. 5B illustrates a second setup or configuration of the venue 500. That is, instead of having tables and chairs, the venue 500 has not been changed to provide a stage where musicians are performing. A crowd of people are gathered to the right of the stage to listen to the music.

As shown, at least part of the stage is directly beneath the AP and the 140, while at least some of the people in the crowd are to the right of the stage. As such, if the antenna 140 was in the same position as shown in FIG. 5A, it would cover some of the stage (where there are essentially no people, or at least, no people who are using Wi-Fi) but would not cover many of the people who are further to the right.

Instead, the AP 105 can use the embodiments described herein to adjust the angle 510 of the antenna 140 so that the radiation pattern 505 is moved to cover the crowd of people. For example, once the crowd arrives for the concert, the user devices can send the probes containing RF data to the AP 105. The antenna adjustor in the AP 105 can then update the setpoint of the PID controller so that the motor moves the antenna 140 as shown by the angle 510 to cover the crowd of people. In this manner, FIGS. 5A and 5B illustrate that the embodiments herein can be used to automatically adjust (i.e., without human interaction) the antenna to optimize communication between the AP 105 and mobile user devices when a physical layout of the venue 500 (or any environment) changes.

In the current disclosure, reference is made to various embodiments. However, the scope of the present disclosure is not limited to specific described embodiments. Instead, any combination of the described features and elements, whether related to different embodiments or not, is contemplated to implement and practice contemplated embodiments. Additionally, when elements of the embodiments are described in the form of “at least one of A and B,” or “at least one of A or B,” it will be understood that embodiments including element A exclusively, including element B exclusively, and including element A and B are each contemplated. Furthermore, although some embodiments disclosed herein may achieve advantages over other possible solutions or over the prior art, whether or not a particular advantage is achieved by a given embodiment is not limiting of the scope of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, the embodiments disclosed herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations and/or block diagrams of methods, apparatuses (systems), and computer program products according to embodiments presented in this disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations and/or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations and/or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations and/or block diagrams.

The flowchart illustrations and block diagrams in the Figures illustrate the architecture, functionality, and operation of possible implementations of systems, methods, and computer program products according to various embodiments. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

In view of the foregoing, the scope of the present disclosure is determined by the claims that follow.

We claim:

1. A Wi-Fi access point (AP), comprising:
a proportional-integral-derivative (PID) controller; and
memory storing an application configured to:
receive radio frequency (RF) data from a plurality of user devices, and
determine a setpoint for the PID controller based on the RF data,
wherein the PID controller is configured to control a motor to adjust a position of an antenna based on the setpoint.

2. The Wi-Fi AP of claim 1, when adjusting the position of the antenna changes a location of a radiation pattern of the antenna.

3. The Wi-Fi AP of claim 2, wherein the RF data indicates which of the plurality of user devices are within the radiation pattern of the antenna and which are outside of the radiation pattern.

4. The Wi-Fi AP of claim 2, wherein adjusting the position of the antenna moves the radiation pattern such that the radiation pattern covers more of the plurality of user devices.

5. The Wi-Fi AP of claim 1, wherein the RF data comprises at least one of a received signal strength indicator (RSSI) or a signal to noise ratio (SNR) corresponding to the plurality of user devices.

6. The Wi-Fi AP of claim 1, wherein the RF data indicates locations of the plurality of user devices.

7. The Wi-Fi AP of claim 1, wherein the application is configured to:
receive updated RF data from the plurality of user devices after the plurality of user devices have moved to different locations in an environment, and
determine an updated setpoint for the PID controller based on the updated RF data, wherein the updated setpoint is different from the setpoint,
wherein the PID controller is configured to control the motor to adjust the position of the antenna based on the updated setpoint.

8. A non-transitory computer readable medium encoding instructions, which, when executed by a processor of an access point (AP), cause the AP to:
receive radio frequency (RF) data from a plurality of user devices, and
determine a setpoint for a PID controller based on the RF data,
wherein the PID controller is configured to control a motor to adjust a position of an antenna based on the setpoint.

9. The non-transitory computer readable medium of claim 8, when adjusting the position of the antenna changes a location of a radiation pattern of the antenna.

10. The non-transitory computer readable medium of claim 9, wherein the RF data indicates which of the plurality of user devices are within the radiation pattern of the antenna and which are outside of the radiation pattern.

11. The non-transitory computer readable medium of claim 9, wherein adjusting the position of the antenna moves the radiation pattern such that the radiation pattern covers more of the plurality of user devices.

12. The non-transitory computer readable medium of claim 8, wherein the RF data comprises at least one of a received signal strength indicator (RSSI) or a signal to noise ratio (SNR) corresponding to the plurality of user devices.

13. The non-transitory computer readable medium of claim 8, wherein the RF data indicates locations of the plurality of user devices.

14. A system, comprising:
an antenna; and
a Wi-Fi access point (AP) configured to:
receive radio frequency (RF) data from a plurality of user devices,
determine a setpoint for a PID controller in the Wi-Fi AP based on the RF data; and
control a motor, using the PID controller, to adjust a position of the antenna based on the setpoint.

15. The system of claim 14, wherein the motor is disposed in the Wi-Fi AP.

16. The system of claim 14, wherein the motor is disposed external to the Wi-Fi AP.

17. The system of claim 14, wherein the antenna is mounted to a side of the Wi-Fi AP.

18. The system of claim 14, wherein the antenna and the Wi-Fi AP are mounted to a common support.

19. The system of claim 14, wherein adjusting the position of the antenna comprises rotating the antenna relative to the Wi-Fi AP.

20. The system of claim 14, when adjusting the position of the antenna changes a location of a radiation pattern of the antenna, wherein the RF data indicates which of the plurality of user devices are within the radiation pattern of the antenna and which are outside of the radiation pattern.
